(19) United States
(12) Patent Application Publication
(10) Pub. No.: US 2017/0171832 A1
(43) Pub. Date: Jun. 15, 2017

(54) CELLULAR CONNECTIVITY FOLLOWING A VOLTE CONNECTIVITY FAILURE

(71) Applicant: General Motors LLC, Detroit, MI (US)

(72) Inventors: Monil H. JOSHI, Windsor (CA); Mohammad ISHFAQ, Northville, MI (US); Waqas HALEEM, Rochester Hills, MI (US); Sandeep S. WARAICH, Tecumseh (CA); David GEORGE, Farmington Hills, MI (US)

(21) Appl. No.: 14/968,832

(22) Filed: Dec. 14, 2015

(51) Int. Cl. H04W 60/04; H04W 4/14; H04W 76/02; H04L 29/06

(52) U.S. Cl. CPC H04W 60/04; H04L 65/1016; H04L 65/1006; H04W 4/14; H04W 76/023; H04W 76/028

(57) ABSTRACT

A communication system and method of providing cellular connectivity in a vehicle using the communication system. The method includes the steps of: registering a telematics unit in the vehicle with an internet protocol (IP) multimedia subsystem (IMS) in a cellular network; using the telematics unit, attempting to establish a voice-over long-term evolution (VoLTE) connection via the IMS with an endpoint device; in response to the attempt, receiving an indication of a connectivity issue; and in response to receiving the indication, automatically attempting to de-register with the IMS.

### TECHNICAL FIELD

The present invention relates to improving cellular connectivity in a vehicle following a voice over LTE (VoLTE) connectivity failure.

### BACKGROUND

VoLTE is an acronym Voice over LTE, which is based on an Internet Protocol (IP) Multimedia Subsystem (a.k.a., IMS) network. The IMS network comprises specific protocols for control and media planes of voice service on LTE, as defined by the 3GPP specification. Thus, this service provides voice service (control and media planes) delivered as data flows within an LTE data bearer. One aim is to eliminate dependency upon legacy circuit-switched voice networks.

When a VoLTE issue is encountered using user equipment (UE), the user may adjust the settings on the UE using its user interface (e.g., via a menu, pop-up, screen prompt, or the like). However, a vehicle having an embedded UE may not have such a user interface; e.g., cellular services are integrated rather than stand alone. Thus, when a VoLTE issue is encountered in a vehicle, there may be no mechanism for ceasing VoLTE usage and ultimately, the embedded UE may repeatedly attempt to reconnect—not providing its typical services. Thus, the vehicle user may be left with a cellular system that is inoperable leading to reduced customer satisfaction. Thus, there is a need for a system which can enable user connectivity when a VoLTE issue is encountered in a vehicle having embedded equipment.

### SUMMARY

According to another embodiment of the invention, there is provided a method of providing cellular connectivity in a vehicle. The method includes the steps of: registering a telematics unit in the vehicle with an internet protocol (IP) multimedia subsystem (IMS) in a cellular network; using the telematics unit, attempting to establish a voice-over long-term evolution (VoLTE) connection via the IMS with an endpoint device; in response to the attempt, receiving an indication of a connectivity issue; and in response to receiving the indication, automatically attempting to de-register with the IMS.

According to another embodiment of the invention, there is provided a method of providing cellular connectivity in a vehicle. The method includes the steps of: registering a telematics unit in the vehicle with an internet protocol (IP) multimedia subsystem (IMS) in a cellular network; using the telematics unit, attempting to establish a voice-over long-term evolution (VoLTE) connection with an endpoint device via the IMS; when an indication of a connectivity issue is received in response to the attempting step, then repeating the attempt to establish the VoLTE connection with the endpoint device; when a threshold quantity of connectivity issue indications are received at the telematics unit within a predetermined period of time, then triggering an attempt to automatically de-register the telematics unit with the IMS; and attempting to establish a circuit-switched voice connection with the endpoint device.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow diagram illustrating a method of providing cellular connectivity for a VoLTE-enabled vehicle;

FIG. 3 is a flow diagram illustrating another method of providing cellular connectivity for the VoLTE-enabled vehicle; and

FIG. 4 is a flow diagram illustrating another method of providing cellular connectivity for the VoLTE-enabled vehicle.

### DETAILED DESCRIPTION OF THE ILLUSTRATED EMBODIMENT(S)

The method described below pertains to providing cellular connectivity in a vehicle following a connectivity issue (e.g., a call-setup failure) using Voice over LTE (VoLTE). In accordance with the current VoLTE protocol, there is currently no fall-back solution (e.g., to a circuit-switched network) when issues are encountered using VoLTE in a vehicle having embedded or integrated cellular equipment. Thus, a vehicle equipped with telematics equipment may repeatedly attempt to connect (and may repeatedly fail)—e.g., until the VoLTE issue is resolved (e.g., on the network-side), or e.g., until the vehicle moves to a new location where the issue is not present. In the mean time, the vehicle user may be unable to exit out of a VoLTE mode (e.g., due to the nature of embedded telematics equipment) and may become frustrated being unable to place any VoLTE calls or otherwise send and/or receive data. The method described below pertains to providing cellular connectivity again during and/or following a VoLTE connectivity issue. In illustrating a connectivity issue, the method is described with respect to a call-setup failure; however, it should be appreciated that other connectivity issues could also occur and similar method steps could be performed. As will be described below in at least one embodiment, the vehicle telematics equipment may automatically de-register from the cellular network in response to the VoLTE connectivity issue and thereafter place a call without using VoLTE (e.g., using a circuit-switched network).

A description of a communication system used by the method immediately follows. Thereafter, the method is described in detail.

### Communications System

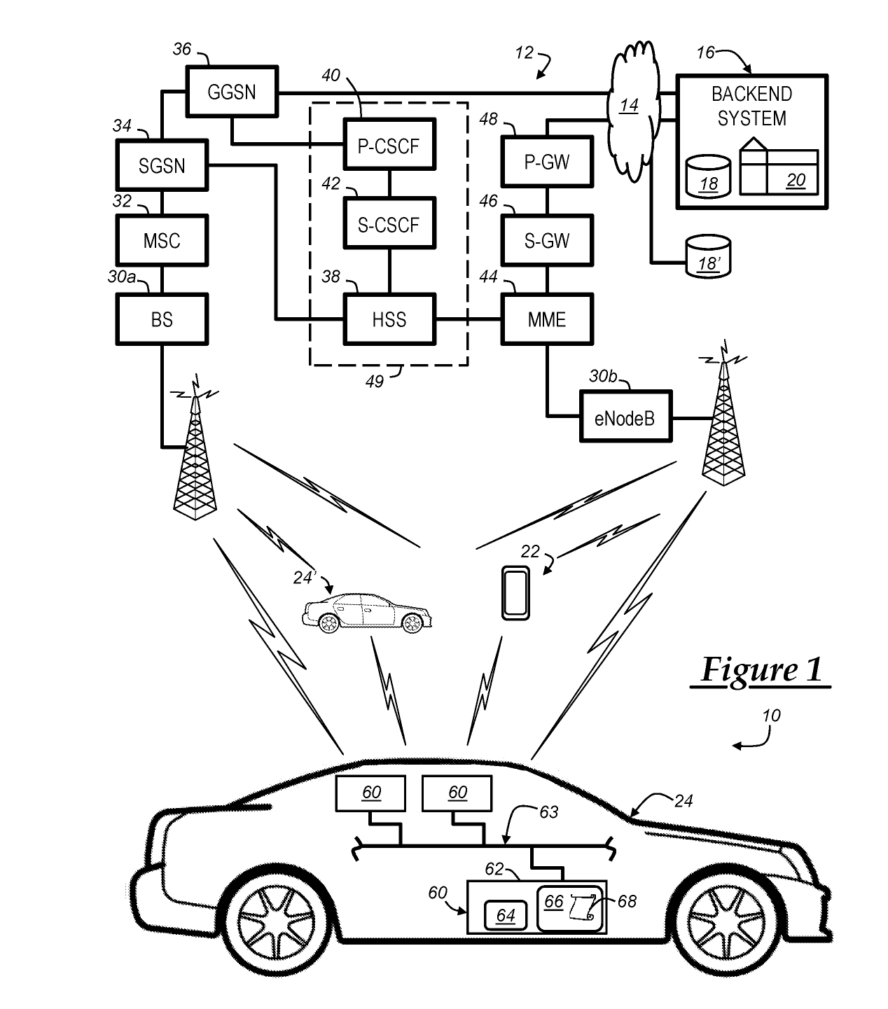

With reference to FIG. 1, there is shown an operating environment that comprises a mobile vehicle communications system 10 and that can be used to implement the method disclosed herein. Communications system 10 generally includes: one or more wireless carrier systems 12; a land communications network 14; a backend system 16 that includes at least one of a remote server 18 or a data service center 20; a mobile device 22; and vehicles 24, 24′. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Wireless carrier system (WCS) or cellular system 12 is preferably a cellular telephone system that includes a plurality of cell towers (only two are shown), one or more radio access network (RAN) nodes 30a, 30b (e.g., these include any infrastructure access point such as a mobile switching center (MSC), a NodeB or eNodeB, a base station (BS), etc.). These RAN nodes include any other networking components required to connect wireless carrier system 12 with land network 14. WCS 12 can implement any suitable communications technology, including for example, analog technologies such as AMPS, or the newer digital technologies such as CDMA (e.g., CDMA2000), GSM/GPRS, LTE or the like.

In FIG. 1, a number of known WCS elements are shown, some of which are directly connected; others are indirectly connected. This WCS architecture is merely an example, and some elements have been omitted in the diagram for clarity; however, it will be appreciated that any and all elements of the WCS architecture are contemplated (e.g., for CDMA architectures, for GSM architectures, LTE architectures, etc.). For example, RAN node 30a (e.g., a base station) may be coupled to MSC 32, serving GPRS support node (SGSN) 34, gateway GPRS support node (GSGN) 36, and ultimately backend system 16. SGSN 34 also is shown connected to a home subscriber server (HSS) 38. And the GGSN 36 also is shown connected to a proxy call session control function (P-CSCF) 40. Further, the HSS 38 and P-CSCF 40 are both shown coupled to a serving call session control function (S-CSCF) 42. The RAN node 30b (e.g., a eNodeB) may be coupled to a mobility management entity (MME) 44, a serving gateway (S-GW) 46, a packet gateway (48), and ultimately backend system 16. In addition, the MME 44 may be coupled to the S-CSCF 42 and P-CSCF 40 via the HSS 38. Again, these features of the WCS 14 are known to skilled artisans and thus will not be described in greater detail here.

FIG. 1 also illustrates a few WCS elements associated with an internet protocol (IP) multimedia subsystem (IMS) 49 (also known as, IP multimedia core network subsystem). As will be appreciated by skilled artisans, the IMS is a collection of different functions used for the purpose of delivering IP multimedia services; it is not a hardware box or module, as the name ‘subsystem’ suggests. As will be explained in greater detail below, mobile device 22 and vehicles 24, 24′ (via embedded cellular devices) are capable of registering directly on the IMS 49 when in a home or visiting (roaming) network using one or more call session control functions (CSCFs). Following registration with IMS 49, the mobile device 22, the vehicle 24, and/or other UE devices may send or receive data (e.g., multimedia data) via the IMS from one or more remote servers, application servers, and the like. Other features and aspects of IMS 49, as well as the registration and de-registration processes with IMS will be appreciated by skilled artisans.

Land network 14 may be a conventional land-based telecommunications network that is connected to one or more landline telephones and connects wireless carrier system 12 to backend system 16. For example, land network 14 may include a public switched telephone network (PSTN) such as that used to provide hardwired telephony, packet-switched data communications, and the Internet infrastructure. One or more segments of land network 14 could be implemented through the use of a standard wired network, a fiber or other optical network, a cable network, power lines, other wireless networks such as wireless local area networks (WLANs), or networks providing broadband wireless access (BWA), or any combination thereof. Furthermore, data service center 20 need not be connected via land network 14, but could include wireless telephony equipment so that it can communicate directly with a wireless network, such as wireless carrier system 12.

Remote server 18 can be one of a number of computers accessible via a private or public network such as the Internet. Each such server 18 can be used for one or more purposes, such as a web server accessible via land network 14 and/or wireless carrier 12. Other such accessible servers 18 can be, for example: a service center computer where diagnostic information and other vehicle data can be uploaded from the vehicle 24; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 24 or data service center 20, or both. Remote server 18 can also be used for providing Internet connectivity such as DNS services or as a network address server that uses DHCP or other suitable protocol to assign an IP address to the vehicle 24. Other servers 18′ may be used in the method described below which are not associated with backend system 16.

Data service center 20 is designed to provide the vehicles 24, 24′ with a number of different system back-end functions and generally includes one or more switches, servers, databases, live advisors, as well as an automated voice response system (VRS), all of which are known in the art. These various data service center components are preferably coupled to one another via a wired or wireless local area network. Switch, which can be a private branch exchange (PBX) switch, routes incoming signals so that voice transmissions are usually sent to either the live adviser by regular phone or to the automated voice response system using VoIP. The live advisor phone can also use VoIP; VoIP and other data communication through the switch may be implemented via a modem connected between the switch and network. Data transmissions are passed via the modem to server and/or database. Database can store account information such as subscriber authentication information, vehicle identifiers, profile records, behavioral patterns, and other pertinent subscriber information. Data transmissions may also be conducted by wireless systems, such as 802.11x, GPRS, and the like. Although one embodiment has been described as it would be used in conjunction with a manned data service center 20 using a live advisor, it will be appreciated that the data service center can instead utilize VRS as an automated advisor or, a combination of VRS and a live advisor can be used. In at least one embodiment, the center 20 may disable VoLTE functionalities on vehicle 24 and/or vehicle 24′, as will be described in greater detail below.

Mobile device 22 may be any electronic device capable of wireless communication. This may include cellular communication using a wireless service provider (WSP) (e.g., voice and/or data calls), short range wireless communication (SRWC), or both. Non-limiting examples of SRWC include Wi-Fi, Wi-Fi Direct, Bluetooth, Bluetooth Low Energy (BLE), Near-Field Communication (NFC), etc. Device 22 may include one or more software applications executable using one or more processors, memory devices, or both. At least one software application may be configured to alert backend system 16 (e.g., more specifically data center 20) of a need or request to disable VoLTE functionality at vehicle 24. This will be described in greater detail below.

Non-limiting examples of the mobile device 22 include a cellular telephone, a personal digital assistant (PDA), a Smart phone, a Smart watch, a personal laptop computer or tablet computer having two-way communication capabilities, a netbook computer, a notebook computer, or any suitable combinations thereof. The mobile device 22 may be used inside or outside of vehicle 24 by the vehicle user who may be a vehicle driver or passenger. It should be appreciated that the user does not need to have ownership of the mobile device 22 or the vehicle 24 (e.g., the vehicle user may be an owner or a licensee of either or both).

Vehicle 24 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Vehicle 24 may include electronics such as a microphone, one or more pushbuttons or other control inputs, one or more visual displays, and a number of vehicle system modules (VSMs) 60 for controlling or regulating various vehicle subsystems. Non-limiting examples of VSMs 60 include a body control module (BCM), an engine control module (ECM), and a telematics unit 62 for carrying out vehicle communications as well as performing other vehicle functions. The VSMs 60 and other devices may be interconnected or electrically coupled by one or vehicle communication networks 63 (e.g., by wired bus(es) or by one or more short range wireless communication (SRWC) networks).

It should be appreciated that a second vehicle 24′ is also illustrated in FIG. 1; the user of vehicle 24′ may or may not be associated with the user of vehicle 24. This vehicle 24′ may be similar to vehicle 24; e.g., it may have an embedded telematics unit as well and may be in communication with the backend system 16, as well as other devices (including vehicle 24) (e.g., using the WCS 14 or any other suitable wireless system, e.g., a SRWC network). Thus, vehicle 24′ will not be described in greater detail here.

Telematics unit 62 can be an OEM-installed (embedded) or aftermarket device that is installed in the vehicle and that enables wireless voice and/or data communication over wireless carrier system 12 and via wireless networking. This enables the vehicle 24 to communicate with data service center 20, other telematics-enabled vehicles (not shown), or some other entity or device (such as mobile device 22). The telematics unit preferably uses radio transmissions to establish a communications channel (a voice channel and/or a data channel) with wireless carrier system 12 so that voice and/or data transmissions can be sent and received over the channel. By providing both voice and data communication, telematics unit 62 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the data service center 20) and data communication (e.g., to provide GPS location data or vehicle diagnostic data to the data service center 20), the system can utilize a single call over a voice channel and switch as needed between voice and data transmission over the voice channel, and this can be done using techniques known to those skilled in the art. Cellular communication using the telematics unit 62 may be carried out over the wireless carrier system 12 using a wireless service provider (WSP); and it should be appreciated that the WSP associated with the telematics unit 62 need not be the same WSP associated with the mobile device 22.

According to one embodiment, telematics unit 62 utilizes cellular communication according to either GSM, CDMA, or LTE standards and thus includes a standard cellular chipset for voice communications like hands-free calling, a wireless modem (not shown) for data transmission, an electronic processing device or processor 64, one or more digital memory devices 66, and a dual antenna (not shown). It should be appreciated that the modem can either be implemented through software 68 that is stored in the telematics unit and is executed by processor 64, or it can be a separate hardware component located internal or external to telematics unit 62. The modem can operate using any number of different standards or protocols such as LTE, EVDO, CDMA, GPRS, and EDGE. Wireless networking between the vehicle and other networked devices can also be carried out using telematics unit 62. For this purpose, telematics unit 62 can be configured to communicate wirelessly according to one or more wireless protocols, including short range wireless communication (SRWC) such as any of the IEEE 802.11 protocols, WiMAX, ZigBeeTM, Wi-Fi direct, Bluetooth, Bluetooth Low Energy (BLE), or Near-Field Communication (NFC). When used for packet-switched data communication such as TCP/IP, the telematics unit 62 can be configured with a static IP address or can set up to automatically receive an assigned IP address from another device on the network such as a router or from a network address server.

Processor 64 can be any type of device capable of processing electronic instructions including microprocessors, microcontrollers, host processors, controllers, vehicle communication processors, and application specific integrated circuits (ASICs). It can be a dedicated processor used only for telematics unit 62 or can be shared with other vehicle systems. Processor 64 executes various types of digitally-stored instructions 68, such as software or firmware programs stored in memory 66, which enable the telematics unit to provide a wide variety of services. For instance, processor 64 can execute programs or process data to carry out at least a part of the method discussed herein. For example, processor 64 may be configured (in hardware, software 68, or both) to automatically de-register from an Internet Protocol Multimedia Subsystem (IMS) [also known as, an IP Multimedia Core Network Subsystem (IMS)] when the telematics unit 62 experiences a call set-up failure, as will be explained in greater detail below.

The memory 66 may include computer usable or readable medium, which include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), and magnetic or optical disks or tapes. In at least one embodiment, memory 66 is a non-transitory computer readable medium.

Telematics unit 62 can be used to provide a diverse range of vehicle services that involve wireless communication to and/or from the vehicle. Such services include: turn-by-turn directions and other navigation-related services that are provided in conjunction with the GPS-based vehicle navigation module; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 62, but are simply an enumeration of some of the services that the telematics unit is capable of offering. Furthermore, it should be understood that at least some of the aforementioned modules could be implemented in the form of software instructions saved internal or external to telematics unit 62, they could be hardware components located internal or external to telematics unit 62, or they could be integrated and/or shared with each other or with other systems located throughout the vehicle, to cite but a few possibilities. In the event that the modules are implemented as VSMs 60 located external to telematics unit 62, they could utilize the network connection 63 (e.g., a vehicle bus) to exchange data and commands with the telematics unit.

### Method

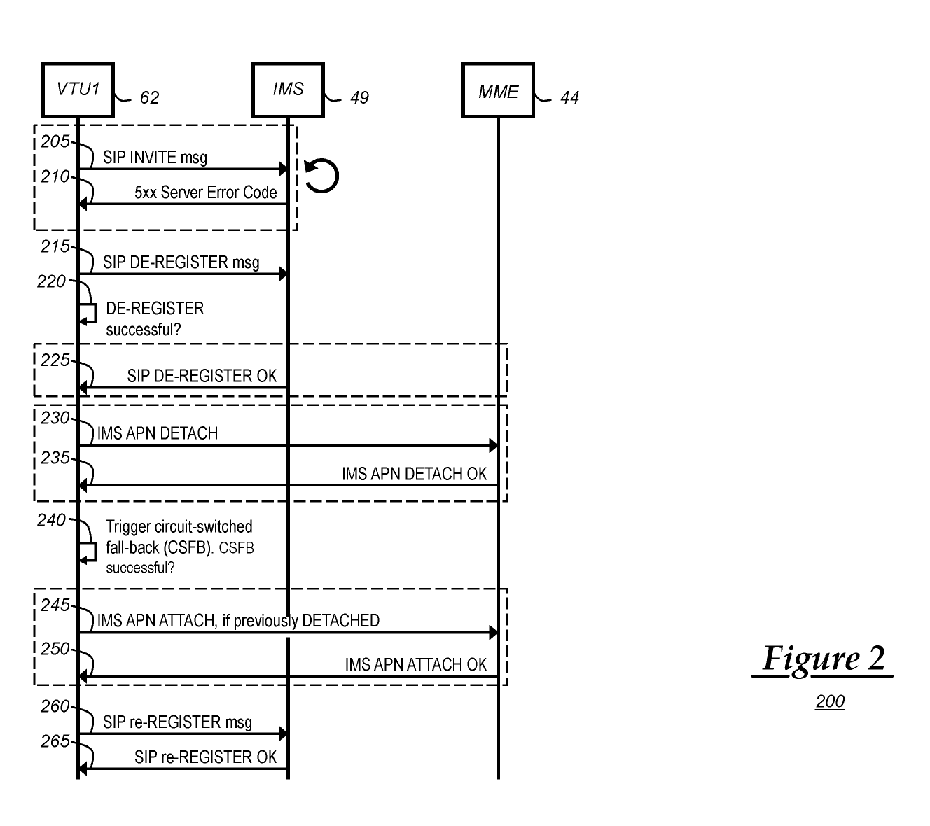

Turning now to FIG. 2, there is shown a flow diagram of an illustrative method 200. The method illustrates providing cellular connectivity to a vehicle experiencing a connectivity issue when using VoLTE and begins with step 205.

In step 205, the vehicle 24 (via telematics unit 62) may provide a session initiation protocol (SIP) INVITE to the IMS 49. As will be appreciated by skilled artisans, an INVITE includes the sender (i.e., vehicle 24) sending a message to another endpoint device requesting that this other endpoint device join an SIP session with vehicle 24. This message is sent via the IMS 49. Next, method 200 proceeds to step 210.

In step 210, the IMS provides an error code (e.g., a type of status code) in response to the SIP INVITE—e.g., a call setup failure of some type. The error code may be associated with one or more error codes illustrated in Table I (see below). The error code, for example, may pertain to a network connectivity issue, a connectivity issue at the vehicle 24, a combination of either, or the like. In at least one instance, the error is at least temporarily fatal—i.e., the telematics unit 62 is unable to establish a VoLTE connection as a result of the error.

It should be appreciated that the error codes of Table I are merely examples to illustrate the method. One or more of the enumerated error codes may not be used (e.g., in at least one embodiment, codes 510-599 may not be used). Further, these error codes are 5xx Status Codes; in other embodiments, 4xx Status Codes, 6xx Status Codes, and the like could be used instead.

Step 205 may be repeated a predetermined number of times before proceeding to step 215. The predetermined quantity may be required to occur within a predetermined interval of time as well. For example, steps 205 (and/or receipt of an error code in step 210) may be required to occur five times within a five minute interval. Of course, this is not meant to be limiting, but instead an example to be illustrative. In at least one embodiment, one or more of the number SIP attempts, the duration of any interval or time period, or both are determined or set by the backend system 16 and provided to the vehicle 24. Furthermore, these parameters may be reconfigurable at a later time (e.g., in response to new instructions provided by the backend system 16). Following steps 205 and/or 210 (e.g., following a predetermined quantity of error codes), the method may proceed to step 215.

TABLE I

| Examples of 5xx Status Codes | |
|---|---|
| (Server Error Codes) | Description |
| 500 Internal Server Error | A generic error message, given when an |
| | unexpected condition was encountered and no |
| | more specific message is suitable. |
| 501 Not Implemented | The server either does not recognize the request |
| | method, or it lacks the ability to fulfill the request. |
| | Usually this implies future availability (e.g., a new |
| | feature of a web-service API). |
| 502 Bad Gateway | The server was acting as a gateway or proxy and |
| | received an invalid response from the upstream |
| | server. |
| 503 Service Unavailable | The server is currently unavailable (because it is |
| | overloaded or down for maintenance). Generally, |
| | this is a temporary state. |
| 504 Gateway Timeout | The server was acting as a gateway or proxy and |
| | did not receive a timely response from the |
| | upstream server. |
| 505 HTTP Version Not Supported | The server does not support the HTTP protocol |
| | version used in the request. |
| 506 Variant Also Negotiates (RFC | Transparent content negotiation for the request |
| 2295) | results in a circular reference. |
| 507 Insufficient Storage (WebDAV; | The server is unable to store the representation |
| RFC 4918) | needed to complete the request. |
| 508 Loop Detected (WebDAV; RFC | The server detected an infinite loop while |
| 5842) | processing the request (sent in lieu of 208 Already |
| | Reported). |
| 509 Bandwidth Limit Exceeded | This status code is not specified in any RFCs. |
| (Apache bw/limited extension) | Its use is unknown. |
| 510 Not Extended (RFC 2774) | Further extensions to the request are required for |
| | the server to fulfil it. |
| 511 Network Authentication | The client needs to authenticate to gain network |
| Required (RFC 6585) | access. Intended for use by intercepting proxies |
| | used to control access to the network (e.g., |
| | “captive portals” used to require agreement to |
| | Terms of Service before granting full Internet |
| | access via a Wi-Fi hotspot). |
| 520 Unknown Error | This status code is not specified in any RFC and |
| | is returned by certain services, for |
| | instance Microsoft Azure and CloudFlare servers: |
| | “The 520 error is essentially a “catch-all” response |
| | for when the origin server returns something |
| | unexpected or something that is not |
| | tolerated/interpreted (protocol violation or empty |
| | response).” |
| 522 Origin Connection Time-out | This status code is not specified in any RFCs, |
| | but is used by CloudFlare's reverse proxies to |
| | signal that a server connection timed out. |
| 598 Network read timeout error | This status code is not specified in any RFCs, but |
| (Unknown) | is used by Microsoft HTTP proxies to signal a |
| | network read timeout behind the proxy to a client |
| | in front of the proxy. |
| 599 Network connect timeout error | This status code is not specified in any RFCs, but |
| (Unknown) | is used by Microsoft HTTP proxies to signal a |
| | network connect timeout behind the proxy to a |
| | client in front of the proxy. |

Next in step 215, telematics unit 62 may attempt to de-register from the IMS 49.

Registration (which occurred previous to step 205) would have included the vehicle providing identifying information as well as information pertaining to its location to an SIP server (for example 18′ shown in FIG. 1). A request for de-registration would include ‘forgetting’ and/or deleting the previously stored registration information associated with telematics unit 62.

In step 220 which follows, it may be determined whether the de-registration was successful. For example, vehicle 24 may receive an indication in step 225 from the IMS 49 indicating de-registration. In at least one embodiment, the IMS 49 provides an affirmance that de-registration occurred (e.g., an OK). This may be received via the telematics unit 62. If this indication is received, the method may skip steps 230 and 235 and proceed to step 240, which is described below.

However, in other instances of step 220, there may be no indication of whether the de-registration was successful. Thus, the method 200 proceed to steps 230 and 235. When, in step 230, telematics unit 62 does not receive the affirmance (OK) or the telematics unit otherwise determines that the IMS 49 did not de-register the unit 62, then the telematics unit may send a message to the MME 44 requesting an IMS access point name (APN) DETACH. This message may be another alternative method by which the telematics unit 62 may disconnect from the LTE network. In response to this request, the MME 44 may send affirmance (e.g., an IMS APN DETACH OK) [step 235]. Following steps 230 and 235, method 200 may advance to step 240.

In step 240, having disconnected from the LTE network, de-registered from VoLTE (IMS), or both, vehicle 24 may attempt to place a circuit-switched call in lieu of the VoLTE call setup failure. Thus, placing the circuit-switched call may operate as a fallback mechanism in order to provide connectivity to users of vehicle 24 in instances where VoLTE fails. In at least one embodiment, step 240 (as well as at least some of the previous steps) may occur automatically (i.e., without user interaction). As previously described, automation is particularly desirable in vehicle implementations where the user equipment (e.g., the telematics unit 62) is an embedded device which is integrated into the vehicle—e.g., and does not have a dedicated user interface (e.g., which is common with other VoLTE devices such as Smart phones, laptops, etc.).

Step 240 further includes determining whether the circuit-switched call is successful (i.e., whether the connection with the other endpoint device was successful). If the circuit-switched call is unsuccessful, the method 200 ends (e.g., steps 245-265 may be skipped). For example, the vehicle 24 may remain unconnected until the VoLTE call setup later becomes successful (or the telematics unit 62 or vehicle 24 restarts (e.g., next ignition cycle), or the like). Or alternatively, the telematics unit 62 may periodically attempt to reconnect the circuit-switched call. If however, the circuit-switched call is successful, the method proceeds to step 245.

In step 245, when the circuit-switched call ends or terminates, the telematics unit may attempt to ATTACH to the IMS APN again (e.g., communicating again with MME 44). In at least one embodiment, both steps 245 and 250 only occur when steps 230 and 235 were performed above (e.g., there is a need to reconnect to MME 44, the LTE network, etc.). Thus, if step 230-235 were skipped above, there is no need to re-ATTACH via the MME 44.

Thus, where the telematics unit 62 performed an IMS APN ATTACH in step 245, the MME 44 may respond (in step 250) with an IMS APN ATTACH OK or affirmance. Thereafter, method 200 proceeds to step 260.

In step 260, the vehicle again attempts to register with the IMS 49 (e.g., sending an SIP register message). In at least one embodiment, the connectivity issue(s) associated with the error code received above are resolved and in step 265, the IMS 49 provides an SIP register OK or affirmance. Thereafter, the vehicle 24 may communicate with other endpoint devices using VoLTE. Following step 265, the method 200 ends.

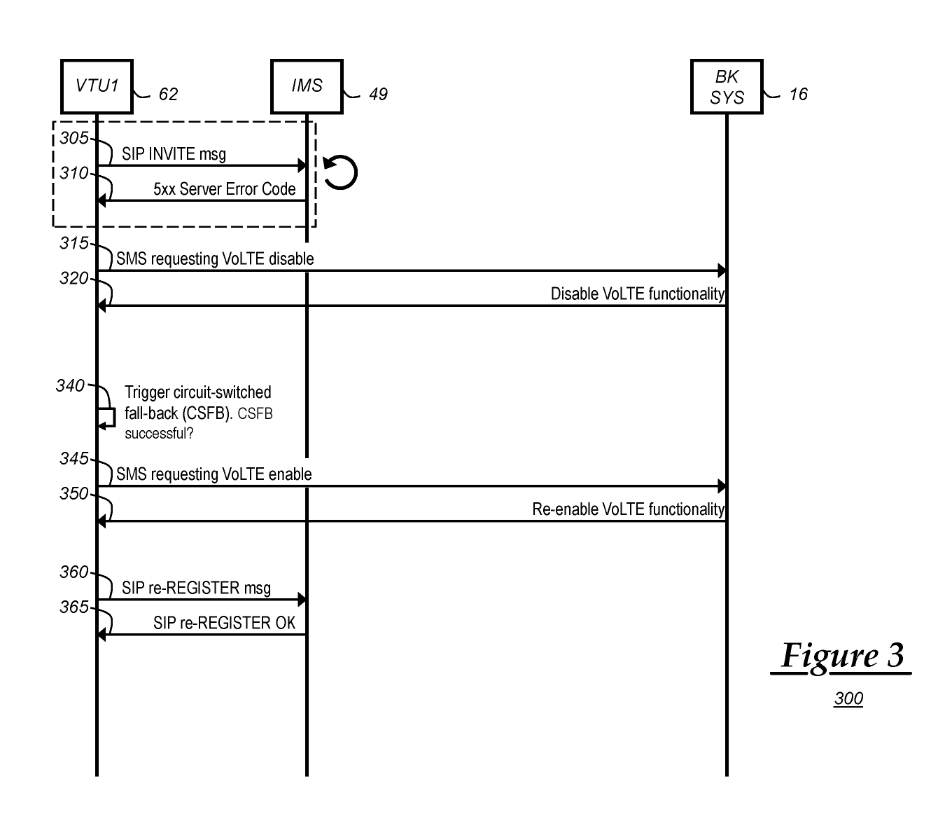

Turning now to FIG. 3, another method (300) illustrates providing cellular connectivity to vehicle 24 which experiences a connectivity issue when using VoLTE. The method begins with steps 305 and 310. Steps 305 and 310 may be identical to steps 205 and 210, respectively. Therefore, these steps will not be re-described here.

In step 315 which follows step 310, the telematics unit 62 may send a message to backend system 16 in response to the error code(s) received (or repeatedly received) in step 310. The message may request that backend system 16 disable VoLTE functionality on telematics unit 62. In at least one embodiment, the telematics unit 62 may not be configured to disable its own VoLTE functionality (i.e., not capable or does not have the authority do to so), whereas the backend system 16 may be configured (e.g., at the server 18) to switch this functionality on and off at vehicle 24. In at least one embodiment, the message to the backend system 16 is an SMS or text message; however, this is merely an example. Other message embodiments may also be used. In at least one implementation, using an SMS message is preferred; e.g., because it may allow telematics unit 62 to communicate with other cellular devices while simultaneously requesting a VoLTE disable of the backend system 16.

Step 320 may occur in response to step 315. In step 320, the backend system 16 may disable VoLTE functionality on the telematics unit 62. This may be an automated process or this disabling step may use a live advisor at the data service center 20. Following step 320, the method proceeds to step 340.

Step 340 may be identical to step 240 (described above with respect to method 200); e.g., it may include both attempting to establish a circuit-switched connection, as well as determining whether the attempted circuit-switched connection was successful. Thus, step 340 will not be re-described further here. When step 340 determines that the circuit-switched connection was unsuccessful, the method may end (e.g., skipping steps 345-365). Again, repeated circuit-switched connection attempts may be made before ending the method 300. Where the circuit-switched call was successful, the method may proceed to step 345.

In step 345, the telematics unit 62 may send a request to the backend system 16 to re-enable vehicle VoLTE functionality (i.e., reverse the effect of step 320). And in step 350, the backend system 16 may perform the re-enablement of VoLTE functionality for vehicle 24. In at least one implementation, the backend system 16 perform re-enablement via a non-IMS network—e.g., via a packet data connection, SMS, or the like. Step 350 may further comprise communicating to telematics unit 62 that the re-enablement has occurred. It will be appreciated that by the backend system 16 attempting to re-enable the telematics unit's VoLTE functionality, the backend system 16 may determine whether the error was at the vehicle 24 or at the network (e.g., the IMS 49). For example, if the re-enable attempt fails as well, then, based on this double-failure, the backend system 16 may determine that the issue exists at the IMS 49. Also, if the re-enable is successful, the backend system 16 may determine an intermittent failure—which may be useful in ultimately isolating the issue's point of origin (e.g., using data from multiple vehicles).

Steps 360 and 365 follow. These steps may be identical to steps 260 and 265 (of method 200); therefore, they will not be re-described here. Following step 365, the method ends.

In other embodiments of method 300, the telematics unit could receive one or more forms of SIP failure feedback (e.g., based on a failed connection attempt) and automatically disable itself. Other implementations are also possible.

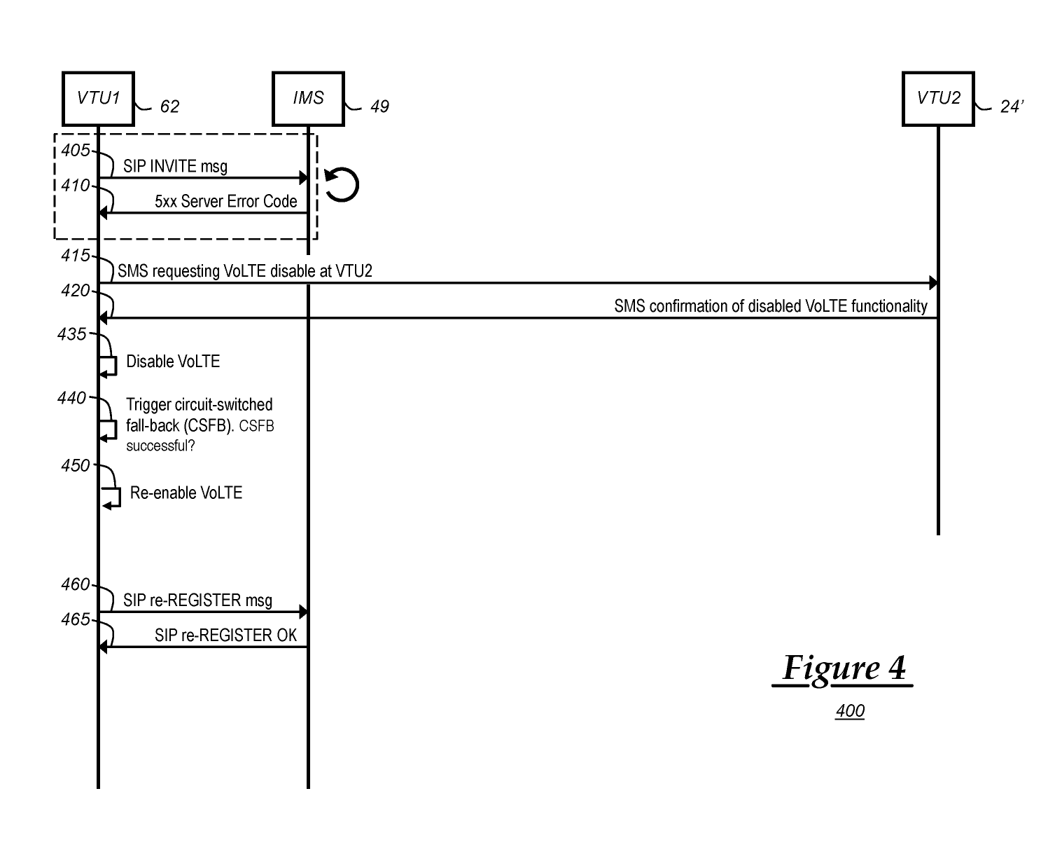

Turning now to FIG. 4, another method (400) illustrates providing cellular connectivity to vehicle 24 which may experience a connectivity issue when using VoLTE. In this method, the vehicle 24 may be trying to use VoLTE to communicate with another endpoint device (e.g., a telematics unit in vehicle 24′). Vehicle 24′ may or may not be able to utilize VoLTE during method 400 (i.e., in at least one implementation, vehicle 24′ is not experiencing VoLTE connectivity issues while vehicle 24 is). The method begins with steps 405 and 410. Steps 405 and 410 may be identical to steps 205 and 210 (method 200), respectively. Therefore, these steps will not be re-described here.

In step 415 which follows step 410, the telematics unit 62 of vehicle 24 may send a message to vehicle 24′ in response to the error code(s) received (or repeatedly received) in step 410 (at telematics unit 62). The message may request that vehicle 24′ disable its VoLTE functionality so that vehicle 24 (via its telematics unit 62) may communicate with vehicle 24′. In at least one embodiment, the message is an SMS or text message; however, this is merely an example. Other message embodiments may also be used. In one embodiment, the message sent by telematics unit 62 performs the disabling of VoLTE functionality of vehicle 24′. This message may include message authentication and the like. In another embodiment, in response to receiving the message from vehicle 24 (step 415), vehicle 24′ requests from backend system 16 that backend system 16 disable its VoLTE functionality (similar to that described in step 315 of method 300, see FIG. 3).

In step 420 (which may be in response to step 415), vehicle 24 receives a message from vehicle 24′ indicating that VoLTE functionality of vehicle 24′ has been disabled. This message may be in an SMS format or any other suitable format. The method proceeds to step 435.

In step 435, vehicle 24 disables its VoLTE functionality in response to the error codes received in step 410. This too may occur similar to that described in step 315 of method 300, see FIG. 3. In addition, step 435 could occur prior to or concurrently with steps 415 and/or 420. Thus eventually, both vehicles 24 and 24′ have disabled VoLTE and may then communicate via a circuit-switched connection—e.g., due to the connectivity problems of at least one of the vehicles.

Step 440 may be similar or identical to step 240; e.g., it may include both attempting to establish a circuit-switched connection, as well as determining whether the attempted circuit-switched connection was successful. In step 440, the attempted circuit-switched connection or call may be between vehicles 24 and 24′. Thus, step 440 will not be re-described in detail here. When step 440 determines that the circuit-switched connection was unsuccessful, the method 400 may end (e.g., skipping steps 450-465). And where the circuit-switched call is successful, the method may proceed to step 450.

In step 450, vehicle 24 may re-enable VoLTE functionality following the termination of the circuit-switched call in step 440. This may be similar to steps 345-350 of method 300; therefore, this will not be re-described here.

Finally, method 400 may perform steps 460 and 465. These steps may be identical to steps 260 and 265; therefore, they will not be re-described here. Following step 465, the method 400 ends. Further, methods 200, 300, and 400 may be performed singly or in combination with one another.

Alternative embodiments also exist. For example, vehicle 24 (when experiencing a VoLTE connectivity issue) may communicate with mobile device 22, e.g., requesting that mobile device 22 communicate to backend system 16 to disable VoLTE functionality on vehicle 24. Backend system 16 may send a message to device 22 that VoLTE functionality has been disabled at the vehicle 24. Thereafter, mobile device 22 may communicate this status to the telematics unit 62. Thus, in at least one embodiment, a mobile device 22 may be an intermediary between vehicle 24 and backend system 16. This may require the mobile device 22 to be previously associated with a user of vehicle 24. Using mobile device 22 may be particularly advantageous in some circumstances—e.g., where the mobile device 22 and vehicle 24 use different wireless service providers (WSPs); e.g., the WSP of vehicle 24 may be experiencing an outage, whereas the WSP of device 22 may not be.

In another embodiment, when the vehicle unsuccessfully attempts to establish the circuit-switched call, the telematics unit 62 could be configured to wait a predetermined period of time before attempting to re-register with the IMS 49—e.g., rather than simply not attempting to re-connect with the IMS 49.

Thus, there has been described several methods of providing cellular connectivity in response to a VoLTE connectivity issue. When a vehicle experiences a VoLTE connectivity issue, the vehicle may de-register from a core IMS network or disable its VoLTE functionality (e.g., with the assistance of an associated backend system). Having disabled VoLTE by de-registration or other means, the vehicle may engage in one or more circuit-switched calls before attempting to re-register the IMS core. In this manner, the vehicle user may be able to enjoy cellular services even when the VoLTE system is inoperable.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of providing cellular connectivity in a vehicle, comprising the steps of:
registering a telematics unit in the vehicle with an internet protocol (IP) multimedia subsystem (IMS) in a cellular network;
using the telematics unit, attempting to establish a voice-over long-term evolution (VoLTE) connection via the IMS with an endpoint device;
in response to the attempt, receiving at least one 5xx status code from the IMS indicating a failure to establish the VoLTE connection with the endpoint device; and
in response to receiving the 5xx status code, automatically attempting to de-register the telematics unit with the IMS; and
after the attempt to de-register the telematics unit, automatically attempting to establish a circuit-switched voice connection with the endpoint device.

2. The method of claim 1, wherein registering and de-registering the telematics unit is in accordance with a session initiation protocol (SIP).

3. (canceled)

4. (canceled)

5. The method of claim 1, further comprising:
repeating the attempt to establish the VoLTE connection step one or more times; and
when the 5xx status code is received at the telematics unit a predetermined number of times in response to repeating the attempting step, then triggering the automatic attempt to de-register from the IMS and detaching from the IMS.

6. (canceled)

7. The method of claim 1, further comprising: when establishing the circuit-switched voice connection with the endpoint device is successful, then, following a termination of the circuit-switched voice connection, registering the telematics unit with the IMS.

8. The method of claim 1, wherein, when attempt to de-register fails or when it is unknown whether the telematics unit was actually de-registered from the IMS, then sending a IMS access point name (APN) DETACH message to a Mobility Management Entity (MME).

9. The method of claim 1, further comprising:
after the automatically attempting to de-register step, transmitting a message associated with the 5xx status code to a backend server requesting that the backend server remotely disable VoLTE functionality at the telematics unit.

10. The method of claim 9, wherein the message is a short message service (SMS) message.

11. The method of claim 1, further comprising:
following receipt of 5xx status code, transmitting a message to a mobile device requesting that the mobile device disable VoLTE functionality;
receiving a response message from the mobile device that VoLTE functionality of the vehicle has been disabled; and then
attempting to establish a circuit-switched voice connection with the endpoint device.

12. The method of claim 11, wherein the endpoint device is another vehicle telematics unit.

13. The method of claim 11, wherein the transmitted message, the response message, or both are short message service (SMS) messages.

14. The method of claim 1, further comprising:
following receipt of the 5xx status code, transmitting a message to the endpoint device requesting that the endpoint device disable its VoLTE functionality;
receiving a response message from the endpoint device that VoLTE functionality of the endpoint device has been disabled; and then
attempting to establish a circuit-switched voice connection with the endpoint device.

15. The method of claim 14, wherein the telematics unit is associated with a backend system, wherein the endpoint device is another vehicle telematics unit also associated with the backend system.

16. A method of providing cellular connectivity in a vehicle, comprising the steps of
registering a telematics unit in the vehicle with an internet protocol (IP) multimedia subsystem (IMS) in a cellular network;
using the telematics unit, attempting to establish a voice-over long-term evolution (VoLTE) connection with an endpoint device via the IMS;
when at least one 5xx status code is received from the IMS indicating a failure to connect to the endpoint device in response to the attempting step, then repeating the attempt one or more times to establish the VoLTE connection with the endpoint device;
when a threshold quantity of 5xx status codes are received at the telematics unit within a predetermined period of time, then triggering an attempt to automatically de-register the telematics unit with the IMS; and
attempting to establish a circuit-switched voice connection with the endpoint device.

17. The method of claim 16, further comprising:
establishing the circuit-switched voice connection with the endpoint device;
terminating the circuit-switched voice connection with the endpoint device; and
based on the successful establishment of the circuit-switched voice connection, re-registering the telematics unit with the IMS.

18. The method of claim 17, further comprising:
attempting unsuccessfully to establish the circuit-switched voice connection with the endpoint device; and
based on the unsuccessful attempt, waiting a second predetermined period of time before re-registering the telematics unit with IMS.

19. The method of claim 18, wherein the telematics unit re-registers with the IMS following a vehicle ignition cycle.
